(19) United States
(12) Patent Application Publication
(10) Pub. No.: US 2022/0057225 A1
(43) Pub. Date: Feb. 24, 2022

(54) LANDMARK DETERMINATION

(71) Applicant: INTERNATIONAL BUSINESS MACHINES CORPORATION, ARMONK, NY (US)

(72) Inventors: Jun Qian Zhou, Shanghai (CN); Yi Chen Zhong, Shanghai (CN); Xiao Feng Ji, Shanghai (CN); Neng Zhang, Beijing (CN); Ya Nan Tian, Beijing (CN); Zixuan Wang, Beijing (CN)

(21) Appl. No.: 16/995,871

(22) Filed: Aug. 18, 2020

(51) Int. Cl. G01C 21/36; G09B 29/10

(52) U.S. Cl. CPC G01C 21/3644; G01C 21/3641; G09B 29/106

(57) ABSTRACT

According to embodiments of the present invention, a method, a device and a computer program product for landmark determination are proposed. In the method, a plurality of objects are identified from a plurality of video clips. The plurality of video clips are respectively captured by a plurality of cameras monitoring a geographical area. At least one of uniqueness levels and expected appearance probabilities of each of the plurality of objects in the plurality of video clips are determined. At least one of the plurality of objects is determined to be a landmark of the geographical area based on the at least one of the uniqueness levels and the expected appearance probabilities. In this way, the landmark can be determined accurately and dynamically.

### BACKGROUND

The present invention relates to landmark determination, and more specifically, to a method, a device and a computer program product for determining a landmark of a geographical area from video clips captured by cameras monitoring the geographical area.

Nowadays, map or navigation products have become increasingly popular. Map products can provide various functions, such as for browsing maps, searching for locations, querying bus routes, and viewing real-time traffic conditions, which help users in traveling and in their daily lives. A common navigating approach is to use landmarks. Landmarks can provide a vivid and visual guide to users and help them to reach their intended destinations. However, traditional map products fail to determine an exact landmark of a particular place to guide the users.

### SUMMARY

According to an embodiment of the present invention, there is provided a computer-implemented method. According to the method, a plurality of objects are identified from a plurality of video clips. The plurality of video clips are respectively captured by a plurality of cameras monitoring a geographical area. At least one of uniqueness levels and expected appearance probabilities of each of the plurality of objects in the plurality of video clips are determined. At least one of the plurality of objects is determined to be a landmark of the geographical area based on the at least one of the uniqueness levels and the expected appearance probabilities.

According to another embodiment of the present invention, there is provided an electronic device. The device comprises one or more processors and a memory coupled to the one or more processors and storing instructions thereon. The instructions, when executed by the one or more processors, perform acts including: identifying a plurality of objects from a plurality of video clips, the plurality of video clips being respectively captured by a plurality of cameras monitoring a geographical area; determining at least one of uniqueness levels and expected appearance probabilities of each of the plurality of objects in the plurality of video clips; and determining, based on the at least one of the uniqueness levels and the expected appearance probabilities, at least one of the plurality of objects to be a landmark of the geographical area.

According to another embodiment of the present invention, there is provided a computer program product comprising a computer readable storage medium having program instructions embodied therewith. The program instructions are executable by a processor to cause the processor to perform actions of: identifying a plurality of objects from a plurality of video clips, the plurality of video clips being respectively captured by a plurality of cameras monitoring a geographical area; determining at least one of uniqueness levels and expected appearance probabilities of each of the plurality of objects in the plurality of video clips; and determining, based on the at least one of the uniqueness levels and the expected appearance probabilities, at least one of the plurality of objects to be a landmark of the geographical area.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a flowchart of an example of a method for determining a landmark according to an embodiment of the present invention.

FIG. 5 shows a schematic diagram of an example of a process for determining a landmark according to an embodiment of the present invention.

FIG. 6 shows a flowchart of an example of a method for determining a uniqueness level according to an embodiment of the present invention.

FIG. 7 shows a schematic diagram of an example of a video window according to an embodiment of the present invention.

FIG. 8 shows a flowchart of another example of a method for determining a uniqueness level according to an embodiment of the present invention.

FIG. 9 shows a schematic diagram of an example of an enlarged video window according to an embodiment of the present invention.

FIG. 10 shows a schematic diagram of an example of a shifted video window according to an embodiment of the present invention.

FIG. 11 shows a schematic diagram of an example of a process for determining expected appearance probabilities according to an embodiment of the present invention.

FIG. 12 shows a flowchart of another example of a method for determining a landmark according to an embodiment of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

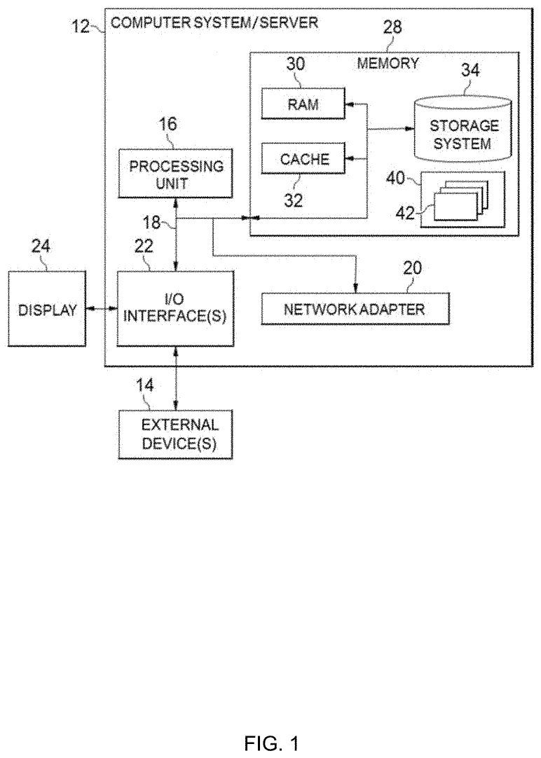

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

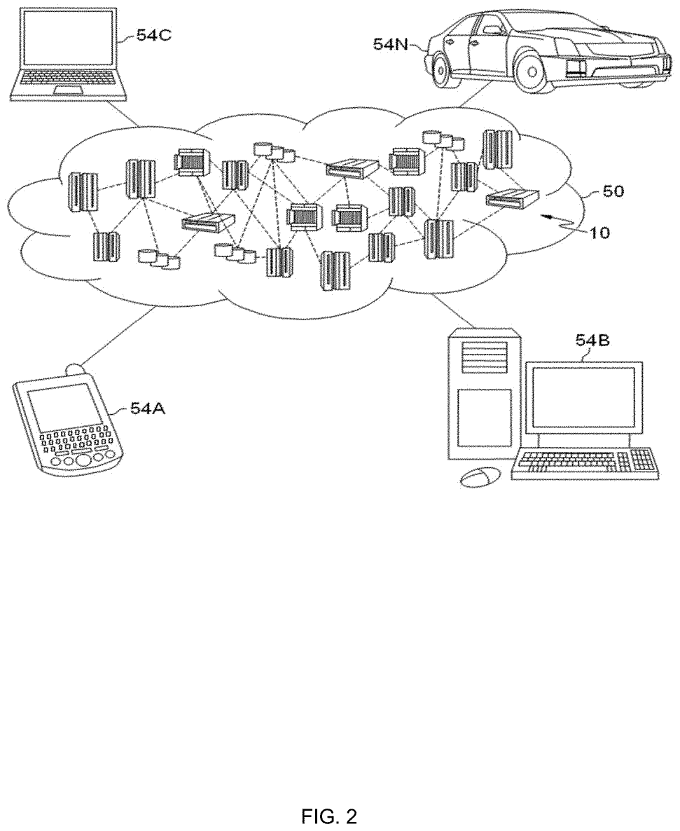

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

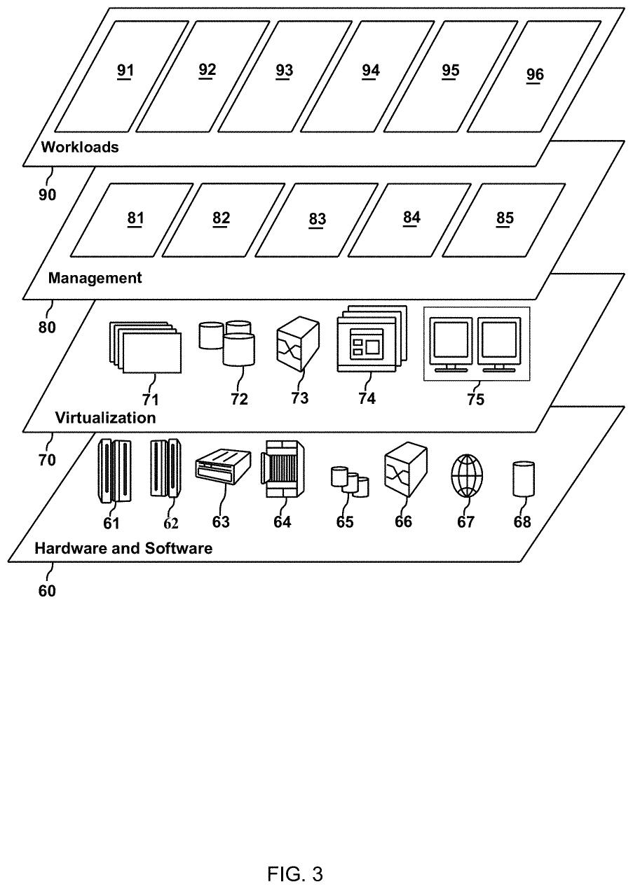

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and landmark determination 96.

As discussed above, the landmarks can provide a vivid and visual guide to the users and help them reach their intended destinations. The users can especially benefit from the landmarks when their destinations do not have navigation information provided by the map products, such as indoor scenarios, or regions without layout maps.

While proper selection of landmarks can be of great help in directing the users, the traditional approaches to select the landmarks are defective. The selected landmarks may not be real-time and may be changed. For example, a grocery store may have already been replaced with a restaurant.

In addition, the selected landmarks may not be typical. For example, a user may be guided to turn left when the user comes across a tree, but the user may be confused when there are trees at both the first and second crosses.

Additionally, the selected landmarks may be temporary objects appearing in a particular time. For example, the temporary object may be a school bus stopped at the station at 8:30 am-9:00 am each day. Such temporary objects may be missed by the user since they do not appear all the time.

Further, the selected landmarks may be outdated street pictures. Street pictures provided by the traditional map products are often generated a long time ago (e.g., several years) and cannot reflect the current or real-time situation, which can sometimes be confusing. Additionally, the traditional map products do not offer the landmarks to effectively aid the users in navigation.

Example embodiments of the present disclosure provide an improved solution for landmark determination. Generally speaking, according to embodiments of the present disclosure, a plurality of objects are identified from a plurality of video clips. The plurality of video clips are respectively captured by a plurality of cameras monitoring a geographical area. At least one of uniqueness levels and expected appearance probabilities of each of the plurality of objects in the plurality of video clips are determined. At least one of the plurality of objects is determined to be a landmark of the geographical area based on the at least one of the uniqueness levels and the expected appearance probabilities. As such, the landmark can be determined accurately and dynamically.

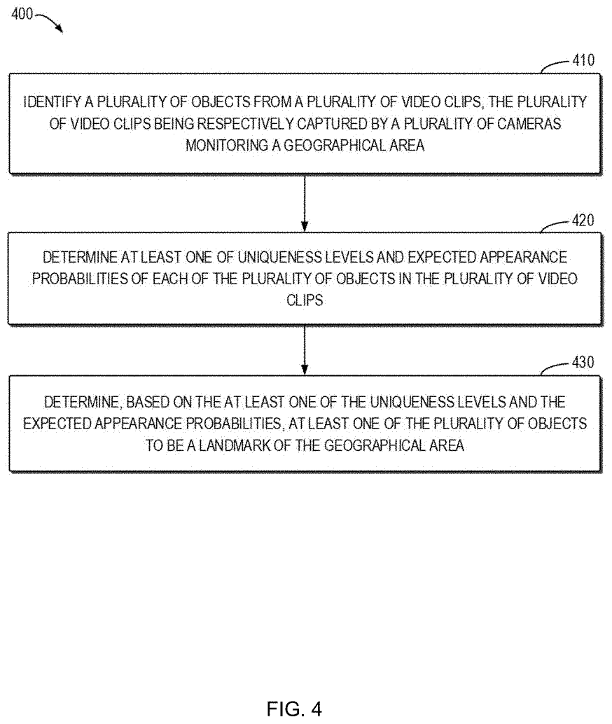

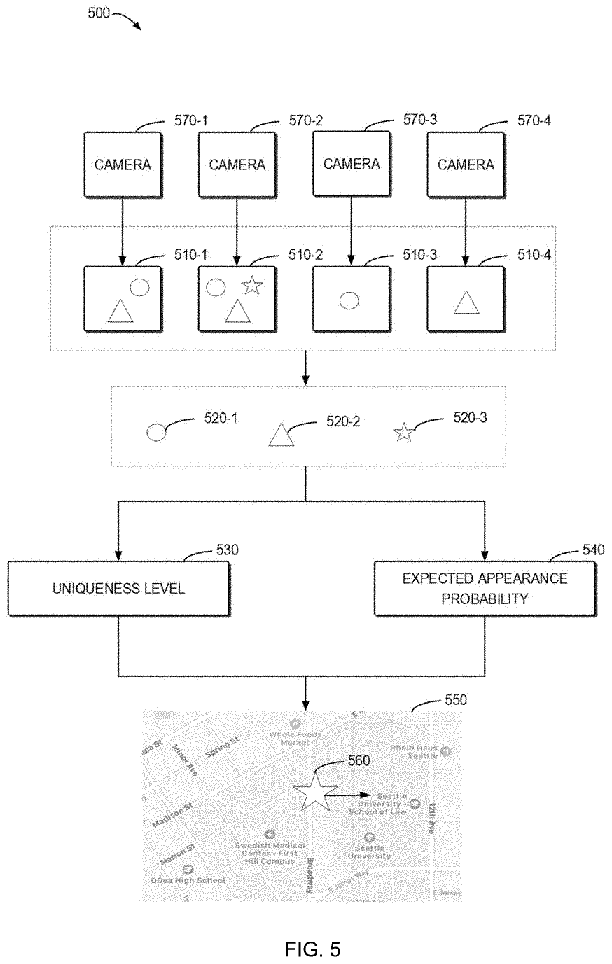

Now some example embodiments will be described with reference to FIGS. 4-12. FIG. 4 shows a flowchart of an example method 400 for determining a landmark according to an embodiment of the present invention. The method 400 may be implemented by the computer system/server 12, or other suitable computer/computing systems. In order to facilitate the understanding of the method 400, the method 400 will be described with reference to FIG. 5, which shows a schematic diagram of an example process 500 for determining a landmark according to an embodiment of the present invention.

For a geographical area, a plurality of cameras may be deployed therein. The plurality of cameras may capture a plurality of video clips of respective sub-areas, and thus monitoring the whole geographical area. Herein, the video clip may be a video, a dynamic image, a still image, a multimedia file or the like. For example, as shown in FIG. 5, there may be four cameras 570-1 to 570-4 (collectively referred to as “camera 570”) set in the geographical area. Each of the cameras 570 captures a video clip, such as video clips 510-1 to 510-4 (collectively referred to as “video clip 510”). It should be understood that the number of the cameras 570 and their respective video clips 510 are intended to be illustrative only and embodiments of the invention are not limited thereto.

The plurality of video clips 510 may be provided to the computer system/server 12. After obtaining these video clips 510, at 410, the computer system/server 12 identifies a plurality of objects from these video clips 510. For example, a circle object 520-1, a triangle object 520-2, and a star object 520-3 (collectively referred to as “object 520”) may be identified from the video clips 510. These objects may represent real world objects, such as a tree, a car, a building. It should be understood that the objects are intended to be illustrative only and embodiments of the invention are not limited thereto.

At 420, the computer system/server 12 determines uniqueness levels 530 and/or expected appearance probabilities 540 of each object 520 in the plurality of video clips 510. The uniqueness level 530 may indicate a degree that an object 520 is unique. An object 520 being unique implies that the object 520 only appears in one or only a few video clips 510, but does not or just infrequently appears in other video clips 510. Such object 520 is representative for a sub-area in the video clip 510 and thus may be a potential landmark for the sub-area. For example, the star object 520-3 only appears in the video clip 510-2 and thus is unique. So, the uniqueness level 530 of the star object 520-3 is considerably high, and accordingly the star object 520-3 may be the potential landmark for the sub-area in the video clip 510-2.

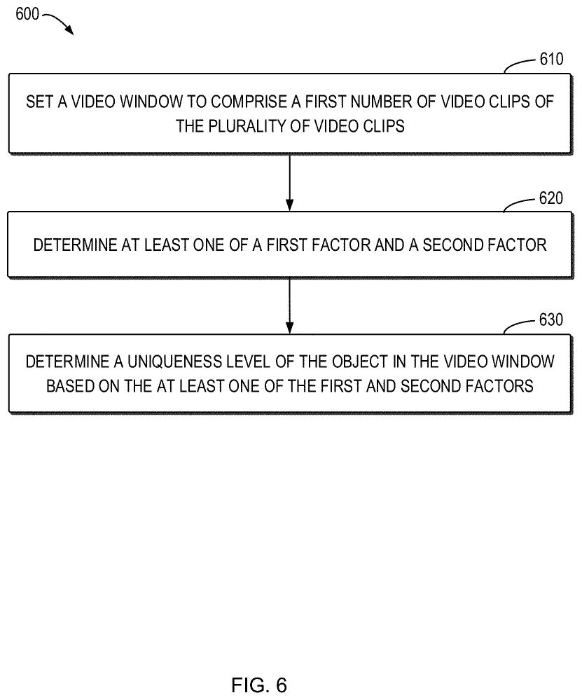

In some embodiments, no object 520 with a sufficiently high uniqueness level 530 can be found in a single video clip 510, and thus no object 520 in the video clip 510 can be the potential landmark. In this case, more video clips 510 may be considered in combination to find a unique object 520. The determination of the uniqueness levels 530 will be discussed below in detail with reference to FIGS. 6-10.

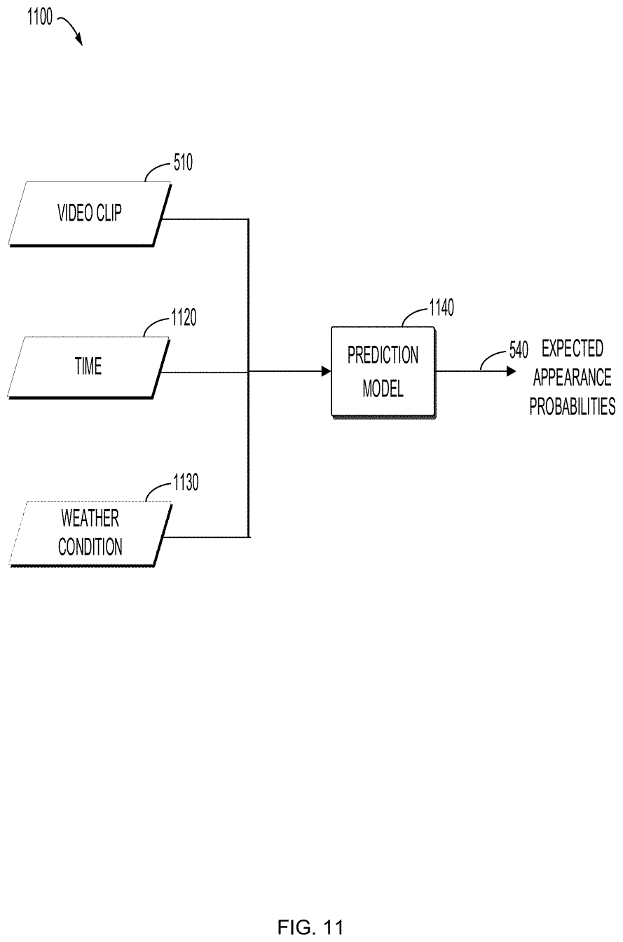

As to the expected appearance probabilities 540, the expected appearance probability 540 may indicate a likelihood that an object 520 appears in a video clip 510. An object 520 with a high expected appearance probability 540 is predicted to be very likely to appear in a sub-area in the video clip 510, and may be a potential landmark for the sub-area. For example, if the expected appearance probability 540 of the star object 520-3 in the video clip 510-2 is determined to be high, the star object 520-3 may be the potential landmark for the sub-area in the video clip 510-2. The determination of the expected appearance probabilities 540 will be discussed below in detail with reference to FIG. 11.

In this event, at 430, the computer system/server 12 determines, based on the uniqueness levels 530 and/or the expected appearance probabilities 540, at least one of the plurality of objects 520 to be a landmark of the geographical area. For example, the star object 520-3 in the video clip 510-2 may be determined to be the landmark 560 due to its high uniqueness level 530 and/or high expected appearance probability 540. In some embodiments, the determined landmark 560 may be displayed on a map 550 of the geographical area for facilitating navigating the user.

In this way, by taking into account the uniqueness levels and/or the expected appearance probabilities of objects found in the video clips of the geographical area, landmarks that are typical and currently existing can be accurately and efficiently determined from these objects, thereby improving the navigation of the user.

The above text describes a general process for determining the landmarks. Specific example processes for determining the uniqueness levels and the expected appearance probabilities will be described below. FIG. 6 shows a flowchart of an example method 600 of determining the uniqueness levels 530 of FIG. 5 according to an embodiment of the present invention. The method 600 may be implemented by the computer system/server 12, or other suitable computer/computing systems.

As discussed above, in some embodiments, no object 520 with a sufficiently high uniqueness level 530 can be found in a single video clip 510. In this case, one or more additional video clips 510 may be considered in combination to find a unique object 520. To deal with such situation, a video window with a dynamic size can be used.

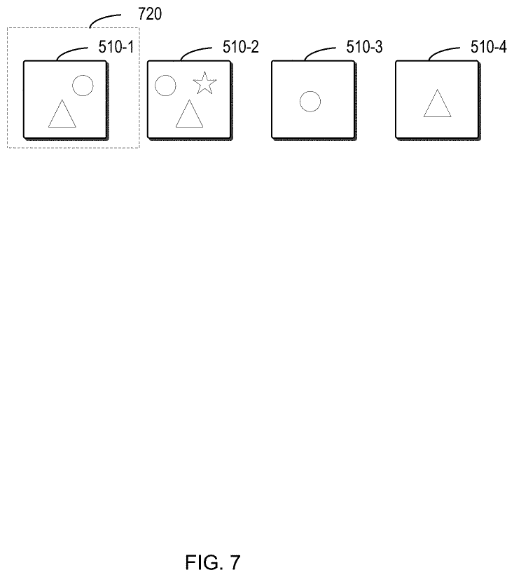

Specifically, at 610, the computer system/server 12 may set a video window to comprise a first number of video clips of the plurality of video clips. FIG. 7 shows a schematic diagram of an example video window 720 according to an embodiment of the present invention. As shown, initially, the video window 720 may be set to comprise one video clip 510-1.

In some cases, since the plurality of cameras 570 monitor the same geographical area, some of the cameras 570 may be proximate to each other, and accordingly the video clips 510 captured by these cameras 570 may overlap or include the same object. Including such video clips 510 into the same video window may improve the relevance of the video clips 510 in the video window, such that the accuracy of the determination of the landmark can be improved. To this end, the computer system/server 12 may identify a moving object that moves across the geographical area and appears in a plurality of historical video clips captured by the plurality of cameras 570. For example, a person traveling through the geographical area may be identified. In some embodiments, a single moving object appearing in all the historical video clips may not be identified. In this case, one or more additional moving objects can be identified for sorting the video clips 510 as described below.

Then, the computer system/server 12 may sort the plurality of cameras 570 based on respective times when the moving object appears in the plurality of historical video clips. Accordingly, the plurality of video clips 510 can thus be sorted based on the sorting result of the plurality of cameras 570. For example, it is assumed that the person appears in the historical video clips captured by the cameras 570-1 to 570-4 in a chronological order. Thus, the order of cameras may be the camera 570-1, the camera 570-2, the camera 570-3, and the camera 570-4. Accordingly, the order of video clips may be the video clip 510-1, the video clip 510-2, the video clip 510-3, and the video clip 510-4. Thereby, the computer system/server 12 may set the video window based on the plurality of sorted video clips, so that video clips that are more likely to be related to each other may be included in the video window.

At 620, for each object of the plurality of objects 510, the computer system/server 12 determines at least two factors related to the uniqueness level 530. As described above, the uniqueness level 530 may indicate a degree that an object 520 is unique. An object 520 being unique implies that the object 520 only appears in one or only a few video clips 510, but does not or just infrequently appears in other video clips 510. In order to reflect such characteristics of the object 520, a first factor is used to reflect the uniqueness of the object 520 in the video window, and a second factor is used to reflect the uniqueness of the object 520 in all the video clips.

In some embodiment, the first factor may be a ratio of a number of occurrence times of the object and a total number of occurrence times of the plurality of objects in the video window. For example, the first factor may be determined as below:

First factor=Count_{object}/Count_{allobject} (1).

where Count_{object} represents the number of occurrence times of the object in the video window, and Count_{allobject} represents the total number of occurrence times of all the objects in the video window.

In addition, the second factor may be associated with a size of the video window and a number of video clips in which the object appears. For example, the second factor may be determined as below:

Second factor=log((TotalCount_{camera}−Size+1)/TotalCount_{object}) (2).

where TotalCount_{camera} represents the total number of cameras, Size represents the size of the video window, and TotalCount_{object} represents the number of video clips in which the object appears.

It is to be understood that a large size indicates that the object is not unique to a video window comprising a small number of video clips and thus implies a low uniqueness level. In addition, the object appearing in a large number of video clips also implies a low uniqueness level. In this case, the second factor decreases with both the increase of the size of the video window and the increase of the number of video clips in which the object appears.

At 630, the computer system/server 12 may determine a uniqueness level 530 of the object in the video window based on the first factor and/or the second factor. For example, the computer system/server 12 may multiply the first factor with the second factor to obtain the uniqueness level 530.

The above text describes the process of determining the uniqueness levels of objects in a video window. After determining the uniqueness levels 530, an object 520 with a high uniqueness level that is unique to the video window can be found. Such object 520 is the potential landmark, and thus the object 520 and its uniqueness level 530 can be recorded and used for determining the landmark. On the contrary, an object 520 with a low uniqueness level is not the potential landmark, and can be abandoned for cost saving. Alternatively, the object 520 with the low uniqueness level can also be recorded and used for determining the landmark, such that the determination will be more accurate.

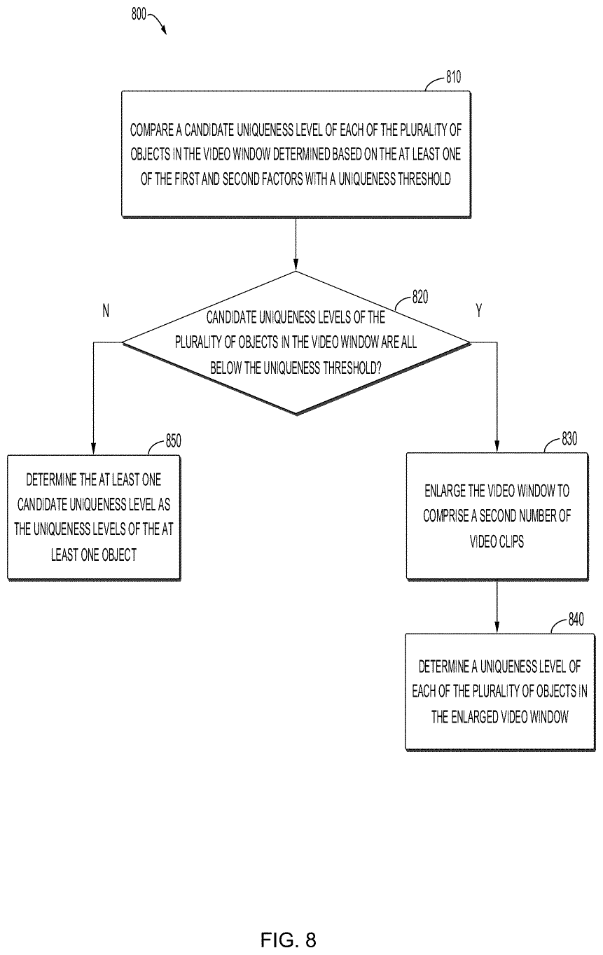

If no object 520 with a high uniqueness level is found, the size of the video window may be enlarged to continue to determine the uniqueness level of each object 520, in attempting to find an object with a high uniqueness level in the enlarged video window, until the size of the video window reaches its upper bound. Such iterative process will be described below with reference to FIG. 8, which shows a flowchart of another example method 800 for determining a uniqueness level according to an embodiment of the present invention.

At 810, the computer system/server 12 may compare a candidate uniqueness level of each object 520 in the video window 720 with a uniqueness threshold. The candidate uniqueness level is a uniqueness level determined based on the first and/or second factor(s), but has not been determined to be the final uniqueness level used for determining the landmark. At 820, the computer system/server 12 may determine whether candidate uniqueness levels of the plurality of objects 520 in the video window 720 are all below the uniqueness threshold.

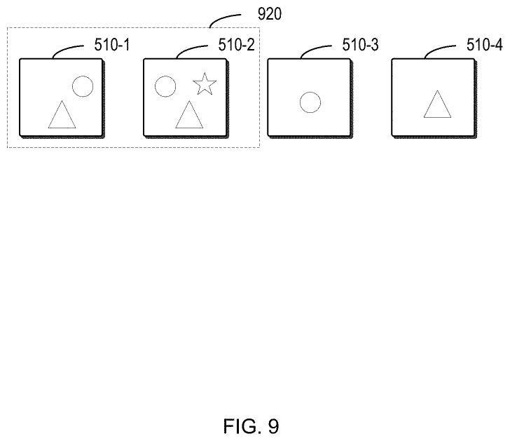

If all the candidate uniqueness levels are below the uniqueness threshold, which means that no unique object is found, the computer system/server 12 may enlarge the video window 720 to comprise a second number of video clips, at 830. An example enlarged video window 920 is shown FIG. 9. It can be seen that, as compared with the initial video window 720 shown in FIG. 7, the enlarged video window 920 comprises one more adjacent video clip 510-2. The enlarged video window is searched for a unique object. In this case, at 840, the computer system/server 12 may determine a uniqueness level of each object 520 in the enlarged video window 920. The determination of the uniqueness level in enlarged video window 920 is similar to that in the initial video window 720, and thus is omitted here.

If at least one candidate uniqueness level of at least one of the plurality of objects 520 exceeds the uniqueness threshold (850), which means that at least one unique object is found, the computer system/server 12 may determine the at least one candidate uniqueness level as the uniqueness levels of the at least one object 520.

In some embodiments, the computer system/server 12 may continue to determine a further uniqueness level of each object 520 in at least one remaining video clip of the plurality of video clips 510 excluded from the video window. For example, if a unique object is found in the video window 920, the video window 920 will return to its original size without being enlarged. Then the video window 920 moves or shifts to a subsequent video clip.

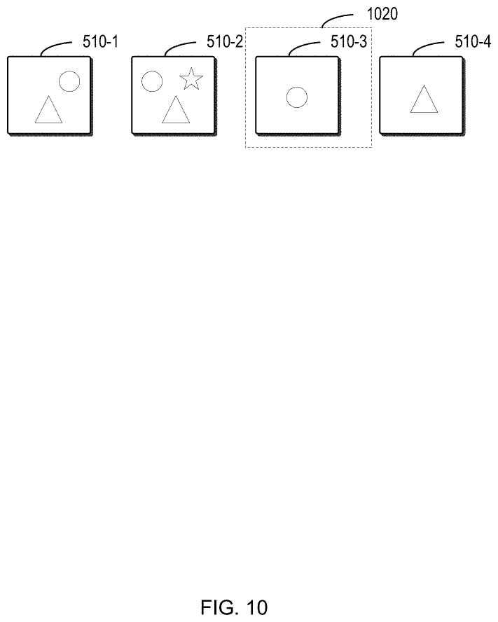

An example of a shifted video window 1020 is shown in FIG. 10. As shown, the size of the video window 1020 returns to one, and a subsequent video clip 510-3 is included in the video window 1020.

In this way, the computer system/server 12 may iteratively determine the uniqueness levels of each of the plurality of objects 520 in the video window until all the video clips 510 are processed.

As discussed above, in addition to the uniqueness levels, the landmarks may also be determined based on the expected appearance probabilities. FIG. 11 shows a schematic diagram of an example process 1100 of determining the expected appearance probabilities 540 of FIG. 5 according to an embodiment of the present invention. The method 1100 may be implemented by the computer system/server 12, or other suitable computer/computing systems.

The computer system/server 12 may obtain a prediction model 1140 representing an association between at least a time when a video clip 510 is captured by a camera 570 and expected appearance probabilities 540 of objects 520 in the video clip 510. For example, the prediction model 1140 may be any model that can predict the appearance probability of an object, for example, a Convolutional Neutral Network (CNN) model, Recurrent Neutral Network (RNN) model such as Long Short-Term Memory (LSTM) RNN model, or the like.

In some embodiments, the prediction model 1140 may be trained based at least in part on a time when a historical video clip is captured by a camera 570 and an object appearing in the historical video clip. The training of the prediction model 1140 can be performed by the computer system/server 12. Alternatively, the training can be performed by any other suitable entities, such as a dedicated computer, a distributed computing system or the like, and the well-trained prediction model 1140 can be deployed into or used by the computer system/server 12. For purpose of illustration only, the training is described as being implemented by the computer system/server 12.

In some embodiments, for each camera 570, the computer system/server 12 may apply the time when the historical video clip is captured and the object appearing in the historical video clip to the prediction model 1140 for training. Usually the video captured by the camera 570 is continuous. In this case, the computer system/server 12 may slice the historical video by a predetermined time interval, such as 15 minutes. The historical video for one day of 24 hours can be sliced into 96 historical video clips with an index of 0 to 95. For each historical video clip, the time when the historical video clip is captured may include month, day of week, and time slice, for example, July, Friday, and time slice 0.

In some cases, the weather conditions can affect the probability of the appearance of an object, such as sunny, rainy or the like. For example, a sunshade will probably appear when it is sunny. In this case, the computer system/server 12 may optionally apply a weather condition when the historical video clip is captured to the prediction model 1140 for training. The weather condition can be acquired from a third-party source or identified from the historical video clip.

The parameters of the prediction model 1140 can be tuned during the training process, such that the predicted object approaches the actual object appearing in the historical video clip. After the training process, the trained prediction model 1140 can be deployed into the computer system/server 12 for determining the expected appearance probabilities 540.

As shown in FIG. 11, for a given video clip of the plurality of video clips 510, the computer system/server 12 may determine a time 1120 when the given video clip 510 is captured. For example, for the video clip 510-2, its capturing time 1120 is March, Monday and time slice 1. Then, the computer system/server 12 may generate respective expected appearance probabilities 540 of the objects 520 in the given video clip 510 by applying the determined time 1120 to the prediction model 1140. For example, the respective expected appearance probabilities of the circle object 520-1, the triangle object 520-2 and the star object 520-3 can be determined.

Optionally, as described above, a weather condition when a video clip is captured by a camera can also be used to train the prediction model 1140. In this case, the computer system/server 12 may further determine a weather condition 1130 when the given video clip 510 is captured. For example, the weather condition 1130 when the video clip 510-2 is captured is sunny. Then, the computer system/server 12 may generate respective expected appearance probabilities 540 of the objects 520 in the given video clip 510 by applying the determined weather condition 1130 and time 1120 to the prediction model 1140.

In some embodiments, the prediction model 1140 may be a layered model. For example, such layered model may include an embedding layer, a neural network layer (such as a RNN layer), a dense layer, and softmax layer. Since the output of the dense layer includes all the expected appearance probabilities 540 of the objects 520 in the video clip 510, the output of the dense layer is used to obtain the expected appearance probabilities 540, rather than the traditional final output of the layered model.

In addition, in some embodiments, the determined respective expected appearance probabilities 540 of each of the objects 520 are compared with a threshold, expected appearance probabilities 540 lower than the threshold can be set to a default value (such as, 0) for simplifying the calculation.

Then, the computer system/server 12 may determine, based on the uniqueness levels 530 and/or the expected appearance probabilities 540, at least one of the plurality of objects 520 to be the landmark 560 of the geographical area. In some embodiments, since the video window is enlarged to include at least two video clips 510, for such enlarged video window, an object 520 may have at least two expected appearance probabilities 540. In determining the landmark 560 by combining the uniqueness levels 530 with the expected appearance probabilities 540, a selection of the expected appearance probabilities 540 needs to be made.

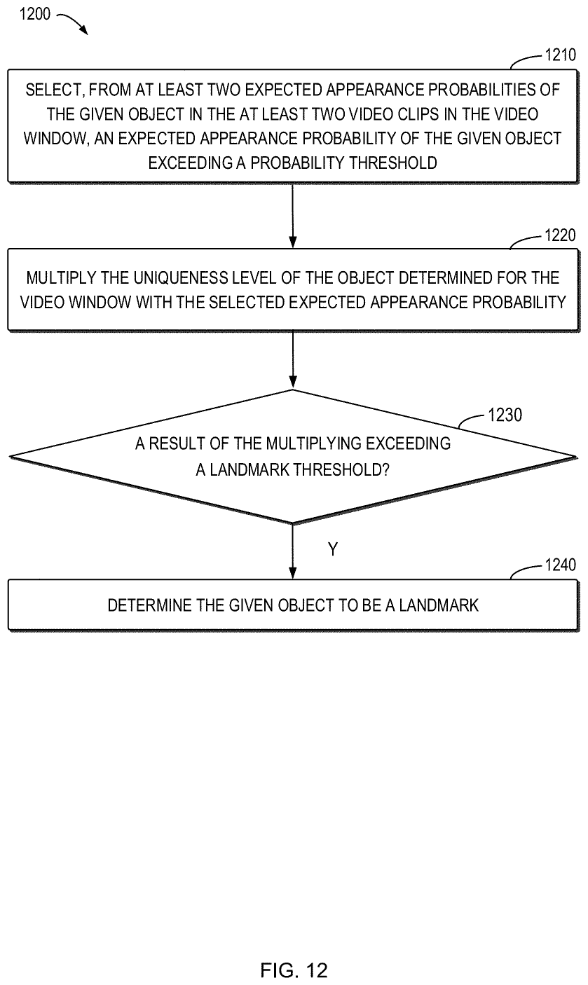

FIG. 12 shows a flowchart of another example of a method 1200 for determining a landmark by combining the uniqueness levels with the expected appearance probabilities according to an embodiment of the present invention. The method 1200 may be implemented by the computer system/server 12, or other suitable computer/computing systems.

At 1210, the computer system/server 12 selects, from the expected appearance probabilities 540 of the given object 520 in the video clips 510 in the video window, an expected appearance probability 540 of the given object exceeding a probability threshold. For example, the computer system/server 12 may select the maximum expected appearance probability 540 of the object 520 in the video window.

At 1220, the computer system/server 12 may multiply the uniqueness level of the object 520 determined for the video window with the selected expected appearance probability. The result of the multiplying indicates a ranking of the object among all the objects. A high rank reflects that the uniqueness level and/or the expected appearance probability of an object 520 are high, and thus can be selected as the landmark. In this case, the computer system/server 12 may compare the result of the multiplying with a landmark threshold (1230). If the result exceeds the landmark threshold, the computer system/server 12 may determine the given object 520 to be the landmark (1240). For example, the object 520 with the highest rank may be determined to be the landmark.

In this way, the landmark is dynamically determined from the currently existing object in the captured video clip. In addition, by considering the uniqueness level, the object that is unique and typical is selected to be the landmark, and thus reducing the potential confusion of the user. Further, with the expected appearance probability, the object expected to appear at a specific time or weather is selected to be the landmark, thereby improving the accuracy of the determination of the landmark.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by one or more processors, a plurality of objects from a plurality of video clips, the plurality of video clips being respectively captured by a plurality of cameras monitoring a geographical area;
determining, by the one or more processors, at least one of uniqueness levels and expected appearance probabilities of each of the plurality of objects in the plurality of video clips; and
determining, by the one or more processors and based on the at least one of the uniqueness levels and the expected appearance probabilities, at least one of the plurality of objects to be a landmark of the geographical area.

2. The computer-implemented method of claim 1, wherein determining the uniqueness levels comprises:
setting, by the one or more processors, a video window to comprise a first number of video clips of the plurality of video clips;
for each object of the plurality of objects:
determining, by the one or more processors, at least one of the following:
a first factor indicating a ratio of a number of occurrence times of the object and a total number of occurrence times of the plurality of objects in the video window, and
a second factor associated with a size of the video window and a number of video clips in which the object appears; and
determining, by the one or more processors, a uniqueness level of the object in the video window based on the at least one of the first and second factors.

3. The computer-implemented method of claim 2, wherein determining the uniqueness level of the object in the video window based on the at least one of the first and second factors comprises:
comparing, by the one or more processors, a candidate uniqueness level of each of the plurality of objects in the video window determined based on the at least one of the first and second factors with a uniqueness threshold;
in accordance with a determination that candidate uniqueness levels of the plurality of objects in the video window are all below the uniqueness threshold:
enlarging, by the one or more processors, the video window to comprise a second number of video clips, and
determining, by the one or more processors, a uniqueness level of each of the plurality of objects in the enlarged video window.

4. The computer-implemented method of claim 2, wherein determining the uniqueness levels further comprises:
determining, by the one or more processors, a further uniqueness level of each of the plurality of objects in at least one remaining video clip of the plurality of video clips excluded from the video window.

5. The computer-implemented method of claim 2, wherein setting the video window comprises:
identifying, by the one or more processors, a moving object moving across the geographical area and appearing in a plurality of historical video clips captured by the plurality of cameras;
sorting, by the one or more processors, the plurality of cameras based on respective times when the moving object appears in the plurality of historical video clips;
sorting, by one or more processors, the plurality of video clips based on the sorting result of the plurality of cameras; and
setting, by the one or more processors, the video window based on the plurality of sorted video clips.

6. The computer-implemented method of claim 2, wherein the second factor decreases with:
the increase of the size of the video window, and
the increase of the number of video clips in which the object appears.

7. The computer-implemented method of claim 1, wherein determining the expected appearance probabilities comprises:
obtaining, by the one or more processors, a prediction model representing an association between at least a time when a video clip is captured by a camera and expected appearance probabilities of a number of objects in the video clip;
for a given video clip of the plurality of video clips:
determining, by the one or more processors, a time when the given video clip is captured; and
generating, by the one or more processors, respective expected appearance probabilities of the number of objects in the given video clip by applying the determined time when the given video clip is captured to the prediction model.

8. The computer-implemented method of claim 7, wherein the prediction model represents an association between a time and a weather condition when a video clip is captured by a camera and expected appearance probabilities of a number of objects in the video clip, and generating the respective expected appearance probabilities comprises:
determining, by the one or more processors, a weather condition when the given video clip is captured; and
generating, by the one or more processors, respective expected appearance probabilities of the number of objects in the given video clip by applying the determined weather condition and time when the given video clip is captured to the prediction model.

9. The computer-implemented method of claim 7, wherein the prediction model is trained based at least in part on a time when a historical video clip is captured by a camera and an object appearing in the historical video clip.

10. The computer-implemented method of claim 1, wherein a uniqueness level of a given object of the plurality of objects is determined for a video window comprising at least two of the plurality of video clips, and determining at least one of the plurality of objects to be the landmark comprises:
selecting, by the one or more processors and from at least two expected appearance probabilities of the given object in the at least two video clips in the video window, an expected appearance probability of the given object exceeding a probability threshold;
multiplying, by the one or more processors, the uniqueness level of the object determined for the video window with the selected expected appearance probability; and
in accordance with a determination that a result of the multiplying exceeding a landmark threshold, determining, by the one or more processors, the given object to be the landmark.

11. An electronic device, comprising:
one or more processors; and
a memory coupled to the one or more processors and storing instructions thereon, the instructions, when executed by the one or more processors, performing acts including:
identifying a plurality of objects from a plurality of video clips, the plurality of video clips being respectively captured by a plurality of cameras monitoring a geographical area;
determining at least one of uniqueness levels and expected appearance probabilities of each of the plurality of objects in the plurality of video clips; and
determining, based on the at least one of the uniqueness levels and the expected appearance probabilities, at least one of the plurality of objects to be a landmark of the geographical area.

12. The device of claim 11, wherein determining the uniqueness levels comprises:
setting a video window to comprise a first number of video clips of the plurality of video clips;
for each object of the plurality of objects:
determining at least one of the following:
a first factor indicating a ratio of a number of occurrence times of the object and a total number of occurrence times of the plurality of objects in the video window, and
a second factor associated with a size of the video window and a number of video clips in which the object appears; and
determining a uniqueness level of the object in the video window based on the at least one of the first and second factors.

13. The device of claim 12, wherein determining the uniqueness level of the object in the video window based on the at least one of the first and second factors comprises:
comparing a candidate uniqueness level of each of the plurality of objects in the video window determined based on the at least one of the first and second factors with a uniqueness threshold;
in accordance with a determination that candidate uniqueness levels of the plurality of objects in the video window are all below the uniqueness threshold:
enlarging the video window to comprise a second number of video clips, and
determining a uniqueness level of each of the plurality of objects in the enlarged video window.

14. The device of claim 12, wherein determining the uniqueness levels further comprises:
determining a further uniqueness level of each of the plurality of objects in at least one remaining video clip of the plurality of video clips excluded from the video window.

15. The device of claim 12, wherein setting the video window comprises:
identifying a moving object moving across the geographical area and appearing in a plurality of historical video clips captured by the plurality of cameras;
sorting the plurality of cameras based on respective times when the moving object appears in the plurality of historical video clips;
sorting the plurality of video clips based on the sorting result of the plurality of cameras; and
setting the video window based on the plurality of sorted video clips.

16. The device of claim 12, wherein the second factor decreases with:
the increase of the size of the video window, and
the increase of the number of video clips in which the object appears.

17. The device of claim 11, wherein determining the expected appearance probabilities comprises:
obtaining a prediction model representing an association between at least a time when a video clip is captured by a camera and expected appearance probabilities of a number of objects in the video clip;
for a given video clip of the plurality of video clips:
determining a time when the given video clip is captured; and
generating respective expected appearance probabilities of the number of objects in the given video clip by applying the determined time when the given video clip is captured to the prediction model.

18. The device of claim 17, wherein the prediction model represents an association between a time and a weather condition when a video clip is captured by a camera and expected appearance probabilities of a number of objects in the video clip, and generating the respective expected appearance probabilities comprises:
determining a weather condition when the given video clip is captured; and
generating respective expected appearance probabilities of the number of objects in the given video clip by applying the determined weather condition and time when the given video clip is captured to the prediction model.

19. The device of claim 11, wherein a uniqueness level of a given object of the plurality of objects is determined for a video window comprising at least two of the plurality of video clips, and determining at least one of the plurality of objects to be the landmark comprises:
selecting, from at least two expected appearance probabilities of the given object in the at least two video clips in the video window, an expected appearance probability of the given object exceeding a probability threshold;
multiplying the uniqueness level of the object determined for the video window with the selected expected appearance probability; and
in accordance with a determination that a result of the multiplying exceeding a landmark threshold, determining the given object to be the landmark.

20. A computer program product, comprising a tangible computer readable storage medium having program instructions embodied therewith, the program instructions executable by a processor to cause the processor to perform actions including:
identifying a plurality of objects from a plurality of video clips, the plurality of video clips being respectively captured by a plurality of cameras monitoring a geographical area;
determining at least one of uniqueness levels and expected appearance probabilities of each of the plurality of objects in the plurality of video clips; and
determining, based on the at least one of the uniqueness levels and the expected appearance probabilities, at least one of the plurality of objects to be a landmark of the geographical area.
